(19) United States
(12) Patent Application Publication
(10) Pub. No.: US 2016/0152480 A1
(43) Pub. Date: Jun. 2, 2016

(54) APPARATUS FOR PRODUCING Si NANOPARTICLES USING MICROWAVE PLASMA AND PRODUCTION METHOD USING THE SAME

(71) Applicant: KOREA INSTITUTE OF ENERGY RESEARCH, Daejeon (KR)

(72) Inventors: Bo-Yun JANG, Daejeon (KR); Joon-Soo KIM, Daejeon (KR); Jin-Seok LEE, Daejeon (KR); Sun-Ho CHOI, Daejeon (KR); Jeong-Boon KOO, Daejeon (KR)

(21) Appl. No.: 14/712,545

(22) Filed: May 14, 2015

(30) Foreign Application Priority Data
Dec. 2, 2014 (KR) 10-2014-0170346

(51) Int. Cl. C01B 33/027; B01J 19/12; H01M 4/36; H01M 4/38; H01M 10/0525

(52) U.S. Cl. CPC C01B 33/027; H01M 4/386; H01M 10/0525; H01M 4/366; B01J 19/126; B01J 2219/0894; B01J 2219/0869; B01J 2219/1215; B01J 2219/1239

(57) ABSTRACT

An apparatus for producing Si nanoparticles using microwave plasma and a method of producing Si nanoparticles using the same are disclosed.

### CROSS REFERENCE TO RELATED APPLICATION

This application claims priority to Korean Patent Application No. 10-2014-0170346 filed on Dec. 02, 2014, and all the benefits accruing therefrom under 35 U.S.C. §119, the contents of which is incorporated by reference in its entirety.

### BACKGROUND

1. Technical Field

The present invention relates to an apparatus for producing Si nanoparticles using microwave plasma and a method of producing Si nanoparticles using the same.

2. Description of the Related Art

Recently, with increasing interest in nanotechnology, demand for nanoparticles has been increasing in many fields.

Some materials exhibit nanoscale-dependent properties which are not obtained in a general particle or bulk size, and are produced into nanoparticles for application to electric/electronic apparatuses, precision machine components, catalysts, medicines, biological engineering, and the like.

Typically, nanoparticles are produced by a wet method, mechanical pulverization, and the like.

However, the wet method requires a complicated process causing low productivity, and has many constraints on commercialization due to discharge of environmentally toxic substances.

In addition, mechanical pulverization has difficulty producing particles having a size of several hundred nanometers or less, and cannot completely prevent inclusion of impurities during the process, thereby making it difficult to produce high quality nanoparticles. Accordingly, a method of producing nanoparticles using plasma is preferred.

A method of producing nanoparticles using RF plasma employs plasma having an ultra-high temperature of 10,000° C. or more and has an advantage in that this method can produce nanoparticles regardless of the phase of a starting material, such as a solid phase, a liquid phase, and a gas phase.

Generally, in the method producing nanoparticles using RF plasma, a micrometer-scale raw material is vaporized while passing through plasma of an ultra-high temperature, and the vaporized particles are grown to nanoscale particles, which in turn are subjected to quenching by a cooling gas, thereby producing nanoparticles.

In this regard, a conventional technique is disclosed in Korean Patent Publication No. 10-2012-0130039 A (publication date: 2012.11.28) entitled “Method and apparatus for producing and coating plasma nanoparticles”.

However, generation of RF plasma requires an expensive vacuum unit increasing manufacturing costs and is disadvantageous in mass production.

### BRIEF SUMMARY

It is one aspect of the present invention to provide an apparatus for producing Si nanoparticles using microwave plasma and a method of producing Si nanoparticles using the same, which overcomes such problems in the related art.

Embodiments of the invention provide an apparatus for producing Si nanoparticles using microwave plasma, which includes: a reactor providing a reaction space; a precursor gas injector disposed above the reaction space and injecting a silicon precursor gas into the reaction space; an output supply unit generating microwaves using a source of a plasma torch provided to the reaction space; a swirl gas injector supplying a plasma formation gas and a reaction gas in swirl form into the reaction space; and a reaction gas injector supplying the reaction gas in linear form into a passage formed from the precursor gas injector to the reaction space, and a method of producing Si nanoparticles using the same.

In the apparatus and method according to the embodiments of the invention, a reaction gas is injected in the swirl form to increase residence time of the reaction gas in plasma, thereby enabling mass production of nanoparticles.

In addition, the reaction gas is supplied in the swirl form and in the linear form at the same time, whereby nanoparticles can be produced in various shapes and various sizes by adjusting a flow rate of the reaction gas in each form, thereby enabling production of nanoparticles according to use thereof.

Further, the apparatus and method according to the embodiments of the invention can produce Si nanoparticles having various properties in terms of nanostructure and electrochemical properties by controlling output of microwaves, a flow rate of a plasma formation gas, a flow rate of a precursor gas, a length of a quartz tube, and the like.

Further, when applied to an anode active material of a lithium secondary battery, nanoparticles produced by the apparatus and method according to the present invention can secure excellent capacity of the secondary battery.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a block diagram of an apparatus for producing Si nanoparticles using microwave plasma according to one embodiment of the present invention;

FIG. 2a is a picture of swirl N₂ plasma, FIG. 2b is a picture of N₂+H₂ plasma, and FIG. 2c is a picture of N₂+H₂+SiC₁₄ plasma;

FIGS. 3a to 3c are pictures of particles produced in a reactor;

FIGS. 4a to 4c are SEM images of Si nanoparticles according to flow rate of hydrogen injected through a swirl gas nozzle;

FIG. 5 shows XRD patterns of Si nanoparticles according to flow rate of hydrogen injected through various swirl gas nozzles under the same conditions;

FIG. 6 shows XRD patterns of Si nanoparticles according to flow rate of hydrogen injected through a reaction gas nozzle;

FIGS. 7a to 7b are TEM images of nanoparticles in Example 1, in which hydrogen was injected through a swirl gas nozzle and a reaction gas nozzle;

FIG. 8 is a graph of spectra showing a chemical bonding state of Si nanoparticles according to flow rate of hydrogen;

FIG. 9 is a graph depicting lifespan characteristics of lithium secondary batteries according to flow rate of hydrogen, which were prepared using Si nanoparticles as an anode material;

FIG. 10 shows XRD patterns of nanoparticles according to length from a plasma start point to a distal end of a quartz tube;

FIG. 11 shows XRD patterns of nanoparticles according to microwave output;

FIGS. 12a to 12c are SEM images of nanoparticles according to microwave output;

FIG. 13 shows XRD patterns of nanoparticles according to flow rate of a plasma formation gas;

FIGS. 14a to 14c are SEM images of nanoparticles according to flow rate of a plasma formation gas;

FIG. 15 shows XRD patterns of nanoparticles according to flow rate of a silicon precursor gas; and

FIGS. 16a to 16c are SEM images of nanoparticles according to flow rate of a silicon precursor gas.

### DETAILED DESCRIPTION

Hereinafter, exemplary embodiments of the present invention will be described in detail with reference to the accompanying drawings. However, it should be understood that the present invention is not limited to the following embodiments and may be embodied in different ways, and that the embodiments are provided for complete disclosure and thorough understanding of the present invention by those skilled in the art. The scope of the present invention is defined only by the claims.

First, an apparatus for producing Si nanoparticles using microwave plasma according to one embodiment of the present invention will be described.

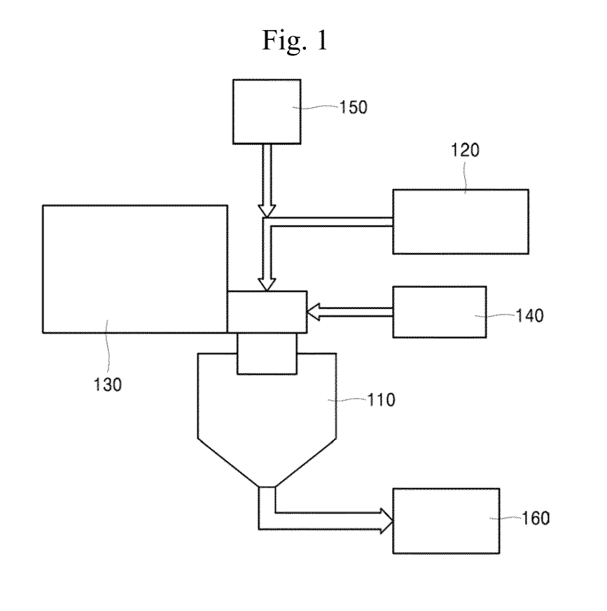

FIG. 1 is a block diagram of an apparatus for producing Si nanoparticles using microwave plasma according to one embodiment of the present invention.

Referring to FIG. 1, the apparatus for producing Si nanoparticles using microwave plasma according to one embodiment includes: a reactor 110 providing a reaction space; a precursor gas injector 120 disposed above the reaction space and injecting a silicon precursor gas into the reaction space; an output supply unit 130 generating microwaves using a source of a plasma torch provided to the reaction space; a swirl gas injector 140 supplying a plasma formation gas and a reaction gas in swirl form into the reaction space; and a reaction gas injector 150 supplying the reaction gas in linear form into a passage formed from the precursor gas injector to the reaction space.

According to the present invention, the apparatus for producing Si nanoparticles using microwave plasma may further include a particle collector 160 that is disposed at a rear side of the reactor and collects Si nanoparticles.

The reactor 110 defines a space in which nanoparticles will be produced by plasma. Plasma is generated in the reaction space of the reactor 110 by microwaves generated from a magnetron of the output supply unit 130, whereby the reaction gas supplied in the swirl form and the linear form is reacted with the silicon precursor gas by the plasma to produce nanoparticles in the reaction space of the reactor 110.

The precursor gas injector 120 is disposed above the reaction space and injects the silicon precursor gas into the reaction space. The silicon precursor gas is obtained by vaporization of liquid SiCl₄, which is a precursor of silicon. That is, while passing through a preheater, liquid SiCl₄ produced by bubbling with argon gas as a carrier gas is vaporized and injected into the reactor 110.

For production of nanoparticles, hydrogen is injected as the reaction gas together with the precursor gas into the reactor 110.

In the present invention, hydrogen is supplied through two paths, that is, the swirl gas injector 140 and the reaction gas injector 150.

When hydrogen is supplied into the reaction space through the swirl gas injector 140, which supplies the reaction gas (hydrogen) and the plasma formation gas in the swirl form, the plasma formation gas generates a swirl and stays in plasma form for a longer period of time.

At this time, by adjusting a flow rate of hydrogen while supplying hydrogen through the reaction gas injector 150, which supplies the reaction gas in the linear form into the passage formed from the precursor gas injector to the reaction space, it is possible to produce particles having various particle characteristics while securing high productivity.

Then, the produced nanoparticles attached to an inner wall of the reactor or to the particle collector 160 are removed for collection, and generated acid gas and waste gas are discharged through a post-process apparatus.

As described above, the apparatus according to the present invention can produce nanoparticles having various particle characteristics while securing high productivity through adjustment of the flow rate of hydrogen supplied as the reaction gas. In the present invention, among swirl gases supplied in the swirl form into the reaction space, the flow rate of the reaction gas depends upon the amount of the silicon precursor (ml), and may be in the range of 1 slpm/ml to 10 slpm/ml. If the flow rate of the reaction gas supplied in the swirl form is less than 1 slpm/ml, it is difficult to form Si particles or a trace amount of particles is formed and is difficult to collect. If the flow rate of the reaction gas supplied in the swirl form is greater than 10 slpm/ml, plasma can become unstable and be removed.

On the other hand, the flow rate of the reaction gas supplied in the linear form into the passage formed from the precursor gas injector to the reaction space depends upon the amount of the silicon precursor (ml) and may be in the range of 1 slpm/ml to 25 slpm/ml. If the flow rate of the reaction gas supplied in the linear form is less than 1 slpm/ml, particle formation efficiency is decreased to 10% or less that of the precursor gas, and if the flow rate of the reaction gas supplied in the linear form is greater than 25 slpm/ml, plasma can become unstable and be removed.

The plasma formation gas supplied into the reaction space is N₂, and the flow rate of the plasma formation gas depends upon applied output and may be in the range of 5 slpm/kW to 15 slpm/kW. If the flow rate of the plasma formation gas is less than 5 slpm/kW, a quartz tube acting as a plasma formation guide is overheated and melted, and if the flow rate of the plasma formation gas is greater than 15 slpm/kW, plasma density is increased. However, in this case, the flow speed of the plasma formation gas is also increased to reduce residence time of reactants, thereby making it difficult to complete reaction.

In the present invention, the amount of the silicon precursor injected into the reaction space depends upon applied output and may be in the range of 0.1 to 10.0 ml/kW at 25° C. If the amount of the silicon precursor is in this range, it is possible to obtain Si nanoparticles allowing control of crystallinity. If the amount of the silicon precursor injected into the reaction space is less than 0.1 ml/kW, a trace amount of Si nanoparticles will be produced, coarsening of the nanoparticles can occur due to an excess of output, and a nitride such as Si₃N₄ can be formed. In addition, if the amount of the silicon precursor gas is more than 10.0 ml/kW, synthesis of Si nanoparticles is not completed due to lack of output, thereby providing unreacted byproducts.

In the present invention, the silicon precursor may be injected in a gaseous phase through vaporization, thereby securing uniform reaction in the plasma while maximizing reactivity. Here, the vaporized precursor gas may have a temperature of 100° C.˜350° C. If the temperature of the precursor gas is less than 100° C., the precursor gas is likely to be condensed within the reactor and can remain as an unreacted by-product, and if the temperature of the precursor gas is higher than 350° C., the precursor undergoes large volume expansion in the course of vaporization so that the precursor gas is injected at high pressure into the reactor, thereby causing unstable plasma.

In the present invention, the reaction space may be provided with the quartz tube in which a plasma zone is created through spark ignition. Here, a distance from a plasma start point to a distal end of the quartz tube is an essential factor determining a length of plasma and depends upon output (kW), and may be in the range of 1 cm/kW to 10 cm/kW. If the distance from the plasma start point to the distal end of the quartz tube is less than 1 cm/kW, a swirling structure is broken, thereby causing dispersion of plasma, and if the distance from the plasma start point to the distal end of the quartz tube is greater than 10 cm/kW, an excess of particles can be attached to the quartz tube and coarsening of produced Si particles occurs.

The Si nanoparticles may be produced in various shapes by the apparatus according to the present invention, and, particularly, may include core-shell structure nanoparticles.

The Si nanoparticles produced by the apparatus according to the present invention may have a size of 20 nm˜150 nm and may have a Si core-SiOx shell structure (0≦x<2).

Next, a method of producing Si nanoparticles using microwave plasma according to one embodiment of the invention will be described.

According to the embodiment of the invention, the method of producing Si nanoparticles using microwave plasma is performed using an apparatus for producing Si nanoparticles using microwave plasma, which includes: a reactor 110 providing a reaction space; a precursor gas injector 120 disposed above the reaction space and injecting a silicon precursor gas into the reaction space; an output supply unit 130 generating microwaves using a source of a plasma torch provided to the reaction space; a swirl gas injector 140 supplying a plasma formation gas and a reaction gas in swirl form into the reaction space; and a reaction gas injector 150 supplying the reaction gas in linear form into a passage formed from the precursor gas injector to the reaction space, wherein the precursor gas, the plasma formation gas, and the reaction gas react with one another along a swirl in the reactor.

Details of process conditions for operating the apparatus for realizing the method according to the present invention are described above, and thus descriptions thereof will be omitted herein.

When applied to an anode material of a lithium secondary battery, the Si nanoparticles produced by the method according to the present invention can secure excellent capacity of the secondary battery.

Next, the present invention will be described in more detail with reference to inventive examples and comparative examples.

### EXAMPLES

1. Preparation of Si Nanoparticles under different Conditions of Flow Rate of Hydrogen Gas and Injection Method, and Evaluation of Si Nanoparticles

(1) Preparation of Nanoparticles

To confirm properties of Si nanoparticles depending upon a flow rate of a reaction gas, that is, hydrogen, and an injection method (swirl form or linear form), the Si nanoparticles were produced while changing the flow rate of hydrogen from each injector under the same conditions.

Plasma was created in a quartz tube of a reactor by spark ignition while injecting plasma formation gas N₂ in swirl form while applying microwaves of ¼λ. At this time, hydrogen used as a reactant was injected through a swirl gas injector and a reaction gas injector, and a silicon precursor gas was also injected at the same time, thereby producing nanoparticles. Details of process conditions are shown in Table 1.

TABLE 1

| | | | | Flow rate | | |
|---|---|---|---|---|---|---|
| | | | | of gas | | |
| | | Flow rate of | | injected | | |
| | | gas injected | | through | Silicon | |
| | | through swirl | | reaction | precursor | |
| | | gas injector | | gas | gas | Carrier |
| | Output | (slpm) | | injector | (ml) | gas: Ar |
| | (kW) | N₂ | H₂ | (slpm) | @25° C. | (sccm) |
| Comparative | 2.5 | 25 | 0 | 10 | 1 | 50 |
| Example1 | | | | | | |
| Example1 | 2.5 | 25 | 3 | 10 | 1 | 50 |
| Example2 | 2.5 | 25 | 8 | 10 | 1 | 50 |
| Comparative | 2.5 | 25 | 3 | 0 | 1 | 50 |
| Example2 | | | | | | |
| Example3 | 2.5 | 25 | 3 | 5 | 1 | 50 |
| Example4 | 2.5 | 25 | 3 | 15 | 1 | 50 |

(2) Evaluation

1) Characteristics of Plasma

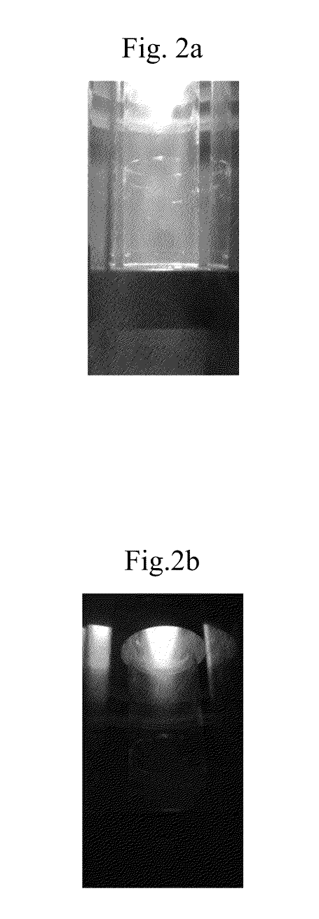

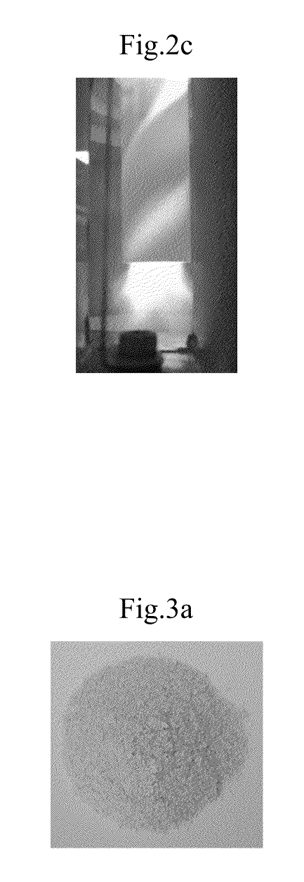

A shape and color of plasma differed according to the kind and flow rate of gas injected into the reactor. FIG. 2a is a picture of swirl N₂ plasma, FIG. 2b is a picture of N₂+H₂ plasma, and FIG. 2c is a picture of N₂+H₂+SiC₁₄ plasma. Plasma of swirl gas N₂ exhibited a pink color, and supply of H₂ changed the color of the plasma into a red color while significantly reducing the volume of the plasma. Upon injection of SiCl₄, the plasma had a substantially white color at a low flow rate of hydrogen and approached an orange color with increasing flow rate of hydrogen. In addition, as soon as SiCl₄ was supplied, the plasma became very long and a flame was also significantly enlarged. When SiCl₄ was supply together with H₂, Si nanoparticles started to be produced and deposited in a swirl form on a quartz tube, as shown in FIG. 2c.

2) Color Characteristics of Nanoparticles

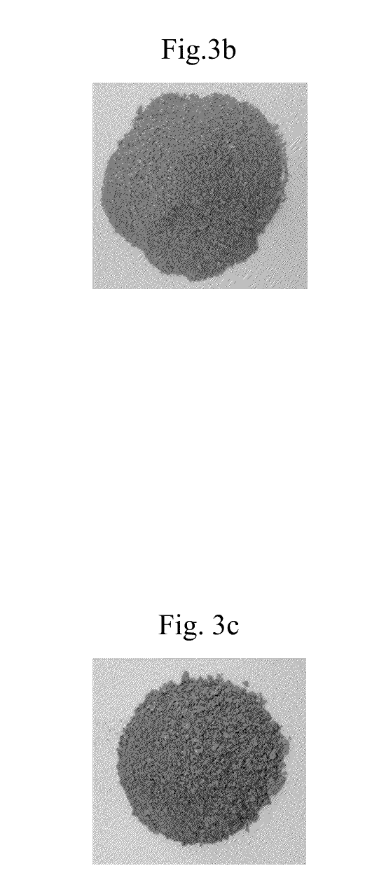

The prepared particles were attached to an inner wall of the reactor and exhibited a color, as shown in FIG. 3. In thermodynamics, the amount of hydrogen consumed by reaction is two times that of SiC₄. However, in fact, a greater amount of hydrogen is used in order to allow the precursor gas SiC₄ to be converted into Si nanoparticles. Particularly, hydrogen injected through the swirl gas nozzle has more influence on the Si nanoparticles than hydrogen injected through the reaction gas nozzle. When hydrogen was not injected through the swirl gas nozzle, nanoparticles (Comparative Example 1) composed of white particles and bright yellow particles non-uniformly mixed and including SiO₂ particles were formed, as shown in FIG. 3a, even by injection of a certain amount of hydrogen through the reaction gas nozzle. When the flow rate of hydrogen injected through the swirl gas nozzle was increased, the nanoparticles prepared in Examples 1 and 2 exhibited a dark yellow color and had a uniform color, as shown in FIGS. 3(b) and 3(c). As the flow rate of hydrogen injected through the reaction gas nozzle was gradually increased while the flow rate of hydrogen injected through the swirl gas nozzle was kept constant, the color of the nanoparticles was gradually darkened. However, when the flow rate of hydrogen injected through the reaction gas nozzle reached a certain level or more, it was substantially difficult to distinguish color variation with the naked eye.

3) Analysis of SEM Image of Nanoparticles

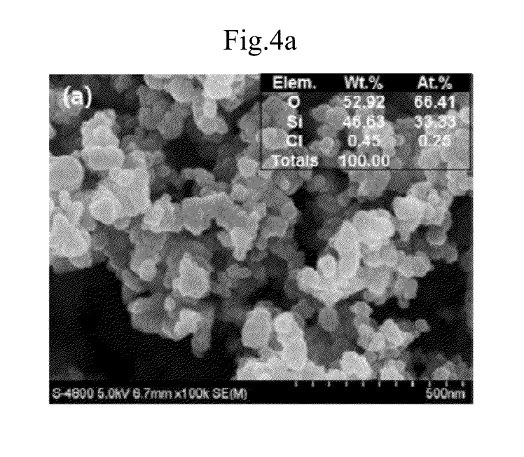

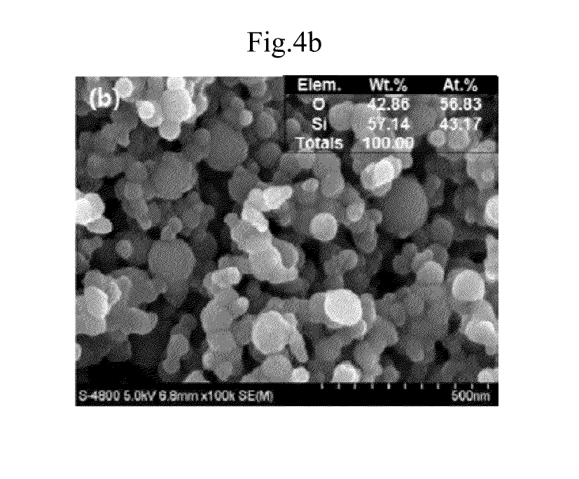

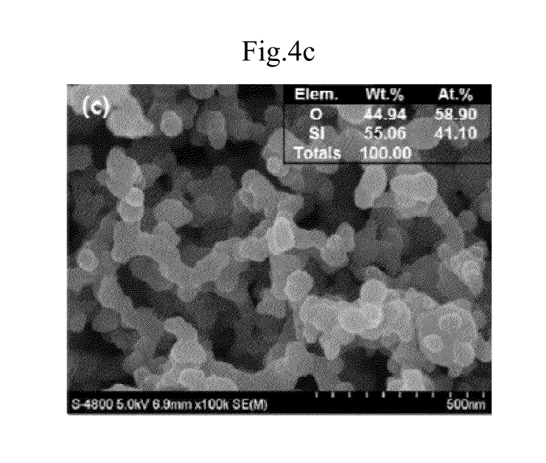

FIG. 4 shows various SEM images of Si nanoparticles according to flow rate of hydrogen injected through various swirl gas nozzles. Under conditions that hydrogen was not injected through the swirl gas nozzle, the nanoparticles had non-uniform shapes and a particle size of 15 nm to 50 nm, as shown in FIG. 4a, even by injection of a certain amount of hydrogen through the reaction gas nozzle. As the flow rate of hydrogen injected through the swirl gas nozzle was increased, spherical nanoparticles having a size of 30 nm to 70 nm were adhered to each other or coarsened, as shown in FIG. 4b (Example 1) and FIG. 4c (Example 2). Under conditions that hydrogen was not injected through the swirl gas nozzle, Cl was detected due to unreacted byproducts on EDX of the nanoparticles even after injection of a certain amount of hydrogen through the reaction gas nozzle.

4) Analysis of XRD Pattern of Nanoparticles

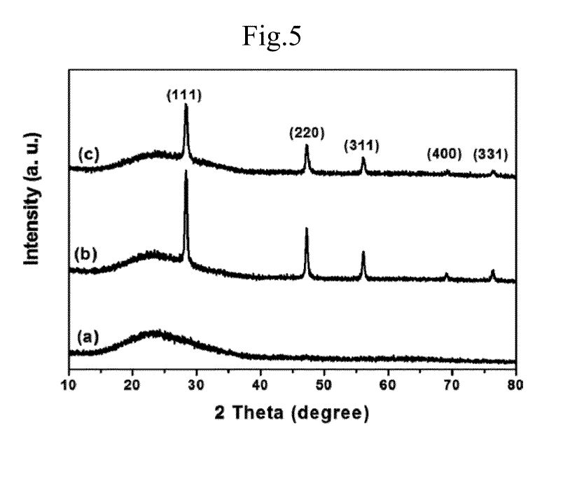

FIG. 5 shows XRD patterns of Si nanoparticles according to flow rate of hydrogen injected through various swirl gas nozzles under the same conditions.

Under conditions that hydrogen was not injected through the swirl gas nozzle as shown in (a) (Comparative Example 1) of FIG. 5, a crystalline phase could not be observed even after injection of a certain amount of hydrogen through the reaction gas nozzle.

After hydrogen was injected through the swirl gas nozzle, as shown in (b) (Example 1) and (c) (Example 2) of FIG. 5, the nanoparticles exhibited peaks corresponding to (111), (220), (311), (400) and (332) planes of Si.

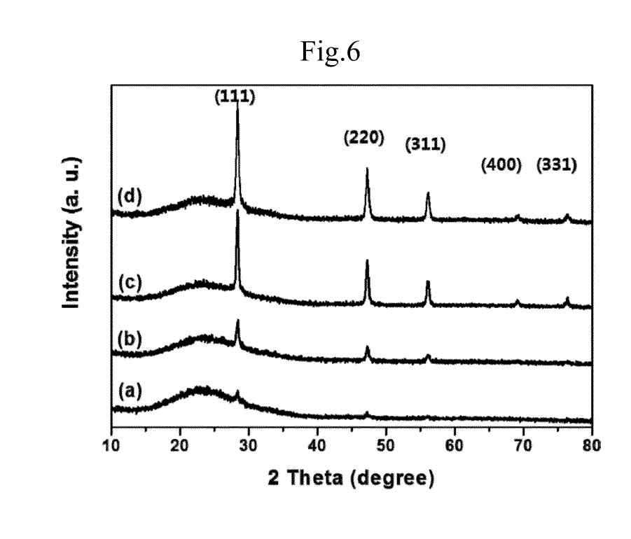

FIG. 6 shows XRD patterns of Si nanoparticles according to flow rate of hydrogen injected through a reaction gas nozzle. These XRD patterns were observed upon injection of certain amounts of hydrogen in swirl form under the same conditions. That is, in Comparative Example 2, Si nanoparticles having a partially crystalline phase were produced by injecting hydrogen in the swirl form, as shown in FIG. 6(a), even without injection of hydrogen through the reaction gas nozzle. In each of Examples 3 and 4, intensity of Si peaks was increased with increasing amount of hydrogen injected through the reaction gas nozzle, as shown in (b) and (c) of FIG. 6. However, when the amount of hydrogen injected through the reaction gas nozzle reached a certain level or more, plasma became unstable and was removed.

5) Confirmation of Core-Shell Structure Nanoparticles

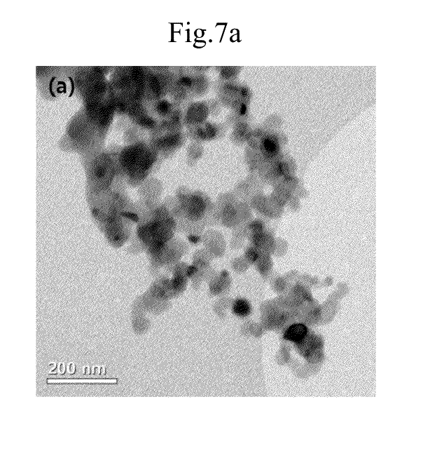

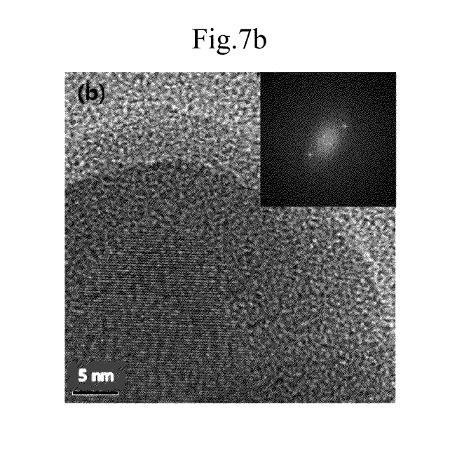

FIG. 7 shows TEM images of nanoparticles, particularly, in Example 1, when hydrogen was injected through a swirl gas nozzle and a reaction gas nozzle. Analysis of a low magnification TEM image (FIG. 7a) shows that there was a necking phenomenon wherein spherical crystalline particles are connected to each other via an amorphous phase, and analysis of a high magnification TEM image (FIG. 7b) shows that a core crystalline Si particle is surround by an amorphous phase. This is a so-called core-shell structure of nanoparticles, in which the amorphous phase was formed in the course of synthesizing the nanoparticles and had a very thick thickness of 10 nm or more unlike a natural oxide layer having a thickness of 2 nm to 3 nm According to EDS showing that the amount of oxygen is high, it can be understood that the amorphous phase on the surface of the core is composed of SiOₓ rather than Si.

6) Confirmation of Chemical Bonding State of Nanoparticles

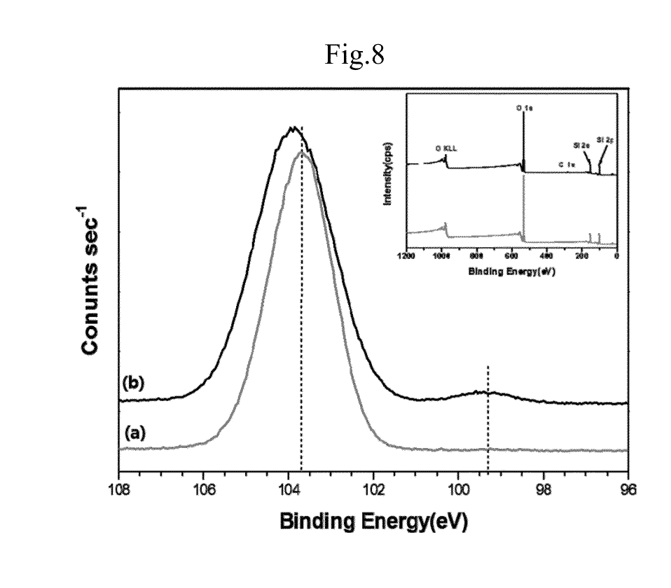

FIG. 8 is a graph of spectra showing a chemical bonding state of Si nanoparticles according to flow rate of hydrogen. A sample of Comparative Example 2 prepared without injecting hydrogen through the reaction gas nozzle exhibited a spectrum having a Si—O band at 101.5˜106 eV, as shown in (a) of FIG. 8. This sample was composed of a single phase SiOₓ (1≦x≦2). On the contrary, a sample of Example 1 prepared by injecting hydrogen through the reaction gas nozzle exhibited a spectrum having a Si—O band at 101.5-106 eV and a Si—Si band at 99.3 eV. This shows that a Si phase and a SiOₓ phase are separately present in the particles, as indicated by TEM analysis. As such, it could be confirmed that the particles were composed of the SiOx phase rather than the Si phase upon injection of a small amount of hydrogen, whereas the particles were composed of the SiOx phase and the Si phase upon injection of a certain amount of hydrogen or more.

7) Confirmation of lifespan of Secondary Battery in Application of Nanoparticles to Anode Material of Secondary Battery

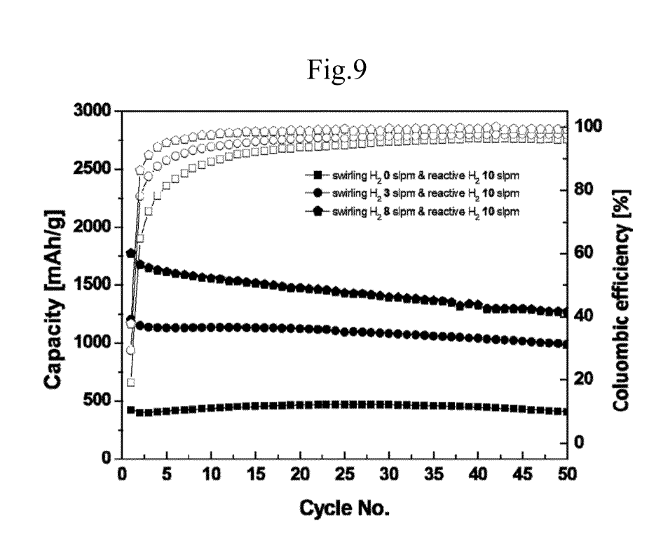

FIG. 9 is a graph depicting lifespan characteristics of lithium secondary batteries according to flow rate of hydrogen, which were prepared using Si nanoparticles as an anode material. After a predetermined cycle of charging and discharging, a sample of Comparative Example 1 had an initial reversible capacity of 450 mAh/g or less. Conversely, a sample of Example 1 had an initial reversible capacity of 1200 mAh/g or more and a capacity retention ratio of 80% or more after 50 cycles. A sample of Example 2 had an initial reversible capacity of 1700 mAh/g or move and a capacity retention ratio of 75% or more after 50 cycles. As such, as the amount of hydrogen injected through the swirl gas injector was increased, the initial reversible capacity of the sample was increased due to influence of the Si phase. In addition, the amorphous SiOx acts as a buffer shell in the core-shell structure, thereby significantly increasing the capacity retention ratio as compared with that of existing Si nanoparticles.

2. Preparation of Si Nanoparticles under different Conditions of Length of Quartz Tube and Microwave output, and evaluation of Si Nanoparticles

(1) Preparation of Nanoparticles

To confirm properties of Si nanoparticles prepared under different conditions of a length of a quartz tube and microwave output, the apparatus according to the present invention was operated under process conditions as shown in Table 2.

TABLE 2

| | | Flow rate of gas | | | | | |
|---|---|---|---|---|---|---|---|
| | | injected through | | Flow rate of gas | Silicon | | Distance from a |
| | | swirl gas injector | | injected through | precursor | Carrier | plasma start point to |
| | Output | (slpm) | | reaction gas | gas (ml) | gas: Ar | a distal end of |
| | (kW) | N₂ | H₂ | injector (slpm) | @25° C. | (sccm) | quartz tube (cm) |
| Example 5 | 2.5 | 25 | 3 | 10 | 1 | 50 | 10 |
| Example 6 | 2.5 | 25 | 3 | 10 | 1 | 50 | 15 |
| Example 7 | 1.5 | 25 | 3 | 10 | 1 | 50 | 15 |
| Example 8 | 2.0 | 25 | 3 | 10 | 1 | 50 | 15 |
| Example 9 | 3.0 | 25 | 3 | 10 | 1 | 50 | 15 |
| Example 10 | 3.5 | 25 | 3 | 10 | 1 | 50 | 15 |

(2) Evaluation

1) XRD Pattern of Nanoparticles according to Length of Quartz Tube

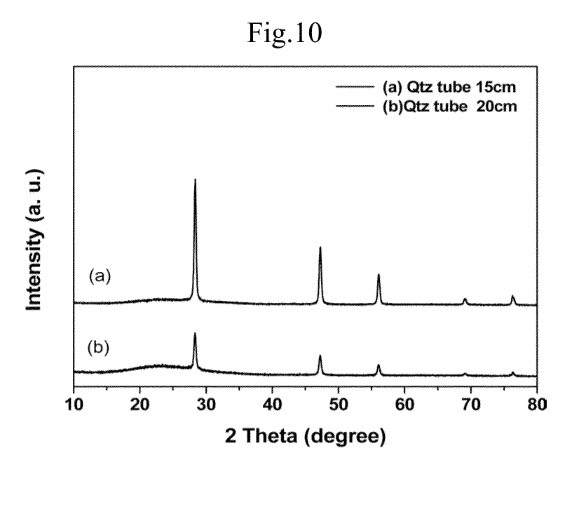

FIG. 10 shows XRD patterns of nanoparticles according to length from a plasma start point to a distal end of a quartz tube. A result of comparing Examples 5 and 6 shows that intensity of crystalline Si peaks was increased with increasing distance from the plasma start point to the distal end of the quartz tube, that is, a section of the quartz tube acting as a plasma guide. This means that, when the section of the quartz tube acting as the plasma guide was increased, swirl-like plasma and a flame could have long lengths to allow increase in residence time of reactants, thereby increasing time for formation of nanoparticles.

2) XRD Pattern and SEM Image of Nanoparticles according to Microwave Output

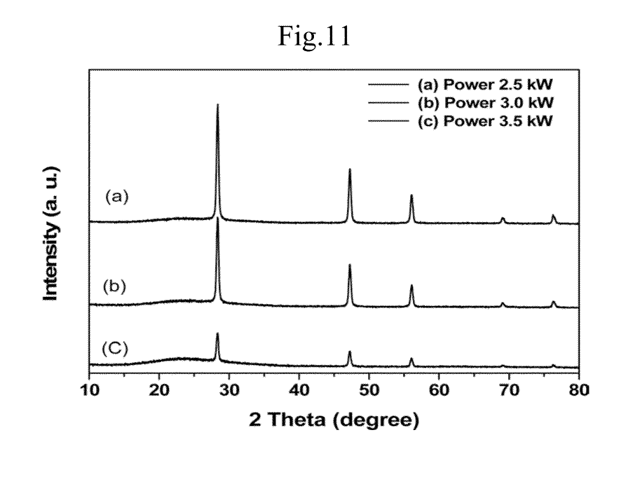

FIG. 11 shows XRD patterns of nanoparticles according to microwave output. A result of comparing Examples 6, 7, 8, 9 and 10 shows that intensity of crystalline Si peaks increased in an initial stage and then decreased with increasing output of microwaves. This means that crystallinity of the nanoparticles increased with increasing output of microwaves up to a certain output and it is necessary to increase the amount of N₂ injected in swirl form at a certain output or more. When the output was increased to a certain level or more without increasing the amount of N₂ injected in the swirl form, plasma became unstable, thereby causing relative deterioration in crystallinity.

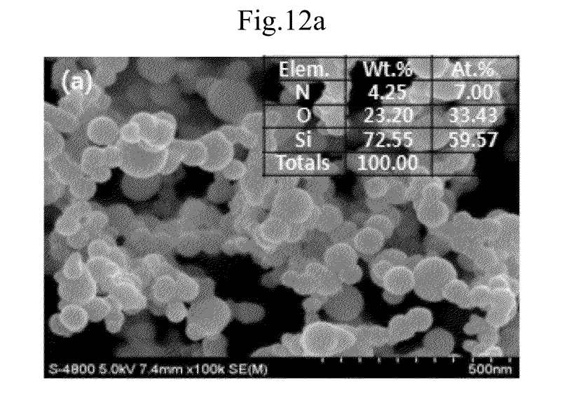

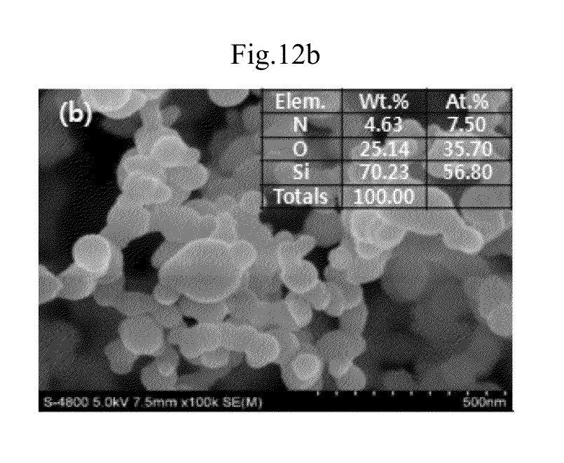

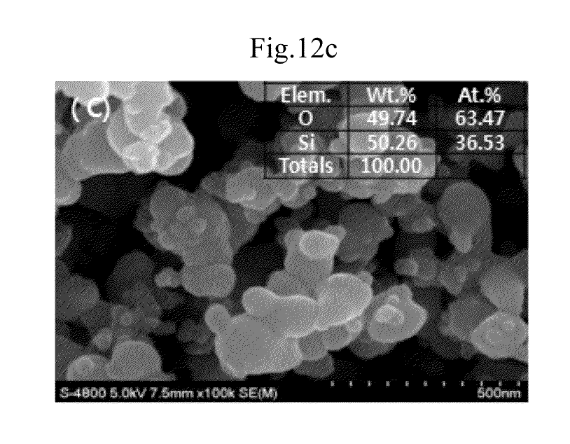

FIG. 12 shows SEM images of nanoparticles according to microwave output. With increasing output of microwaves, a size of the nanoparticles increased and size distribution also widened. In addition, the necking phenomenon between particles became severe, causing formation of secondary particles. This means that, when the output was increased to a certain level or more for formation of the nanoparticles, the necking phenomenon occurred due to sintering between nanoparticles produced by supply of additional energy and the secondary particles were formed when the necking phenomenon continued.

3. Preparation of Si Nanoparticles under different Conditions of Flow Rate of Plasma Formation gas and flow rate of Silicon Precursor Gas, and Evaluation of Si Nanoparticles

(1) Preparation of Nanoparticles

To confirm properties of Si nanoparticles prepared under different conditions of a flow rate of a plasma formation gas and a flow rate of a silicon precursor gas, the apparatus according to the present invention was operated under process conditions as shown in Table 3.

TABLE 3

| | | Flow rate of | | | | | |
|---|---|---|---|---|---|---|---|
| | | gas injected | | | | | |
| | | through swirl | | Flow rate of gas | Silicon | | Distance from a |
| | | gas injector | | injected through | precursor | Carrier | plasma start point |
| | Output | (slpm) | | reaction gas | gas (ml) | gas: Ar | to a distal end of |
| | (kW) | N₂ | H₂ | injector (slpm) | @25° C. | (sccm) | quartz tube (cm) |
| Example11 | 3.5 | 25 | 3 | 10 | 1 | 50 | 15 |
| Example12 | 3.5 | 30 | 3 | 10 | 1 | 50 | 15 |
| Example13 | 3.5 | 35 | 3 | 10 | 1 | 50 | 15 |
| Example14 | 2.5 | 25 | 3 | 10 | 1 | 50 | 15 |
| Example15 | 2.5 | 25 | 3 | 10 | 1.8 | 90 | 15 |
| Example16 | 2.5 | 25 | 3 | 10 | 2.4 | 120 | 15 |

(2) Evaluation

1) XRD Pattern of Nanoparticles according to Flow Rate of Plasma Formation Gas

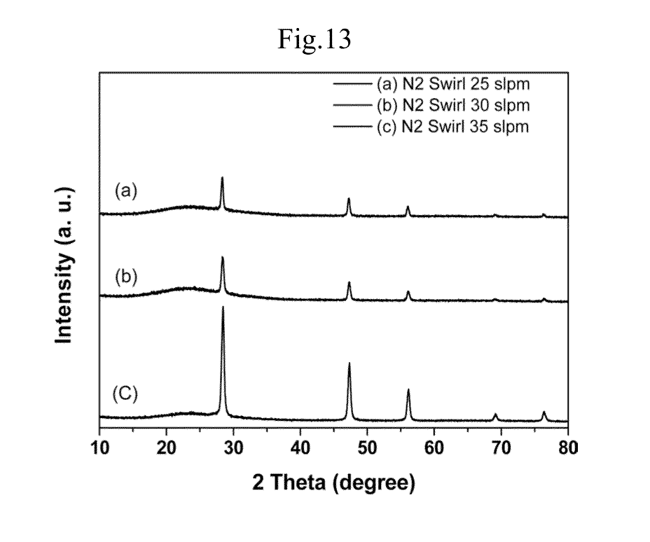

FIG. 13 shows XRD patterns of nanoparticles according to flow rate of a plasma formation gas. A result of comparing Examples 11, 12 and 13 shows that intensity of crystalline Si peaks was increased with increasing flow rate of the plasma formation gas, that is, N₂, injected in swirl form. This is because a higher flow rate of N₂ having a high molecular weight creates a higher density of plasma, thereby increasing ionization and bonding energy of reactants.

2) SEM Image of Nanoparticles according to Flow Rate of Plasma Formation Gas

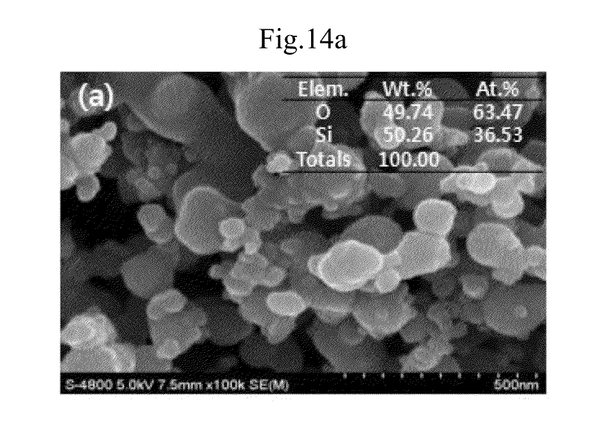

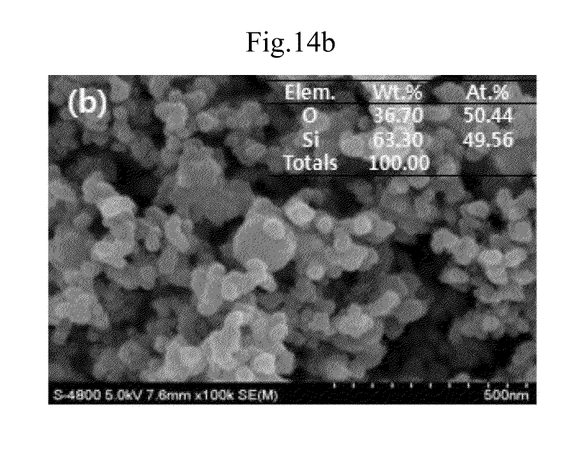

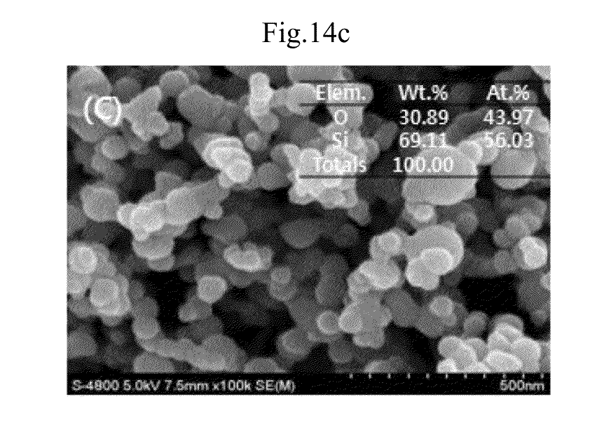

FIG. 14 shows SEM images of nanoparticles according to flow rate of a plasma formation gas. More uniform particles could be produced by increasing the flow rate of the plasma formation gas, that is, N₂ injected in the swirl form. That is, a higher flow rate of N₂ injected in swirl form creates more stable plasma, whereby nanoparticles having a uniform particle size can be produced. However, when the flow rate of N₂ injected in the swirl form was increased to a certain level or more, the length of plasma was reduced again due to an excessive swirl, thereby causing deterioration in crystallinity and non-uniformity of particle size.

3) XRD Pattern of Nanoparticles according to Flow Rate of Silicon Precursor Gas

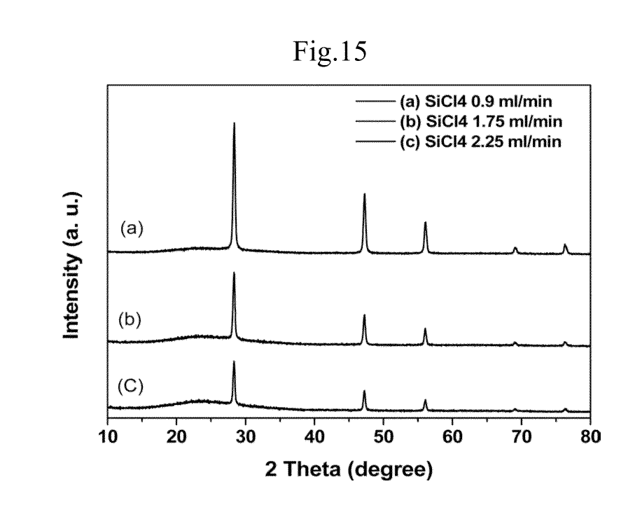

FIG. 15 shows XRD patterns of nanoparticles according to flow rate of a silicon precursor gas.

A result of comparing Examples 14, 15 and 16 shows that intensity of crystalline Si peaks was decreased with increasing flow rate of the silicon precursor (SiC₄). Increase in flow rate of the silicon precursor means that the amount of hydrogen is relatively decreased and thus becomes an important factor in formation of the Si nanoparticles. In this regard, since the silicon precursor gas has a higher molecular weight than other gases injected into the reactor, the length of plasma can be rapidly increased to maintain reaction of the reactant for a longer period of time even by a small amount of the silicon precursor gas. Thus, the intensity of crystalline Si peaks is less susceptible to the flow rate of the silicon precursor gas than other factors.

4) SEM Image of Nanoparticles according to Flow Rate of Silicon Precursor Gas

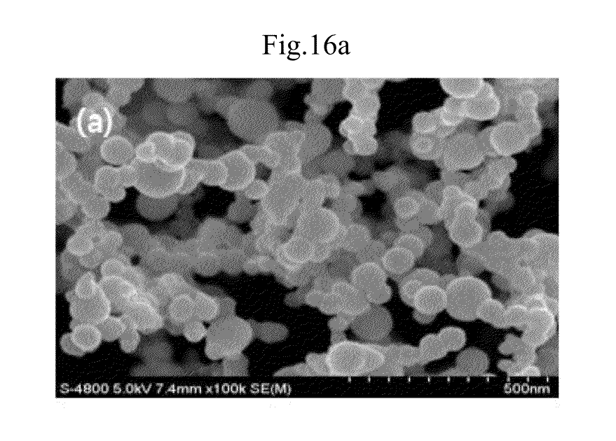

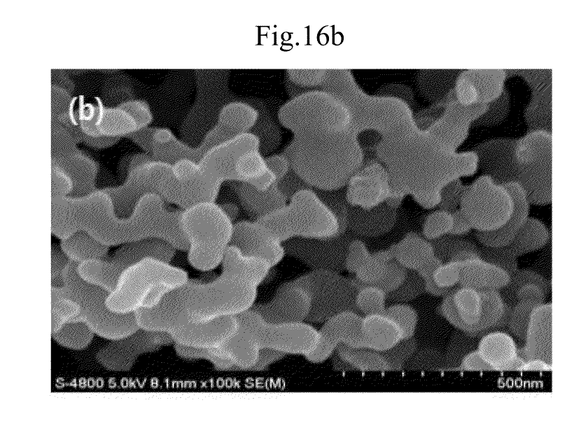

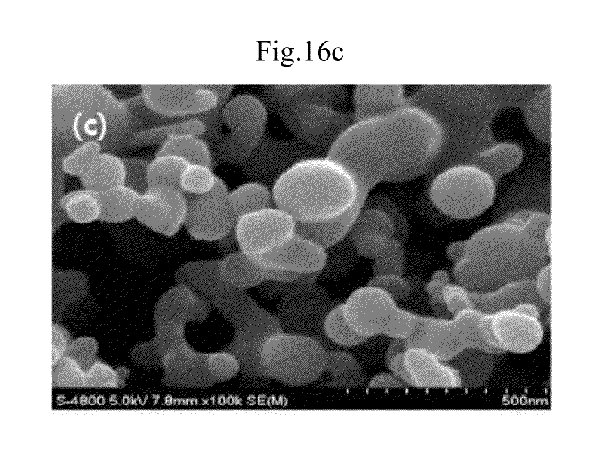

FIG. 16 shows SEM images of nanoparticles according to flow rate of a silicon precursor gas.

The necking phenomenon between particles became severe with increasing flow rate of the silicon precursor (SiCl₄). That is, the density of particles in plasma increases with increasing flow rate of the precursor, whereby a distance between the particles decreases, thereby increasing a possibility of the necking phenomenon between the particles.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. An apparatus for producing Si nanoparticles using microwave plasma, comprising:
a reactor providing a reaction space;
a precursor gas injector disposed above the reaction space and injecting a silicon precursor gas into the reaction space;
an output supply unit generating microwaves using a source of a plasma torch provided to the reaction space;
a swirl gas injector supplying a plasma formation gas and a reaction gas in swirl form into the reaction space; and
a reaction gas injector supplying the reaction gas in linear form into a passage formed from the precursor gas injector to the reaction space.

2. The apparatus for producing Si nanoparticles using microwave plasma according to claim 1, further comprising:
a particle collector disposed at a rear side of the reactor and collecting Si nanoparticles.

3. The apparatus for producing Si nanoparticles using microwave plasma according to claim 1, wherein, among the gases supplied in the swirl form into the reaction space, a flow rate of the reaction gas depends upon an amount of the silicon precursor (ml) and is in the range of 1 slpm/ml to 10 slpm/ml.

4. The apparatus for producing Si nanoparticles using microwave plasma according to claim 1, wherein a flow rate of the reaction gas supplied in the linear form into the passage formed from the precursor gas injector to the reaction space depends upon an amount of the silicon precursor (ml) and is in the range of 1 slpm/ml to 25 slpm/ml.

5. The apparatus for producing Si nanoparticles using microwave plasma according to claim 1, wherein the plasma formation gas supplied into the reaction space is N₂, depends upon applied output, and is supplied at a flow rate of 5 slpm/kW to 15 slpm/kW.

6. The apparatus for producing Si nanoparticles using microwave plasma according to claim 1, wherein an amount of the silicon precursor gas depends upon applied output and is in the range of 0.1 to 10.0 ml/kW at 25° C.

7. The apparatus for producing Si nanoparticles using microwave plasma according to claim 1, wherein the silicon precursor is injected in a gaseous phase through vaporization and the vaporized precursor gas has a temperature of 100° C. to 350° C.

8. The apparatus for producing Si nanoparticles using microwave plasma according to claim 1, wherein the reaction space is provided with a quartz tube, and a distance from a plasma start point to a distal end of the quartz tube depends upon output and is in the range of 1 cm/kW to 10 cm/kW.

9. The apparatus for producing Si nanoparticles using microwave plasma according to claim 1, wherein the produced Si nanoparticles comprise core-shell structure nanoparticles.

10. The apparatus for producing Si nanoparticles using microwave plasma according to claim 1, wherein the produced Si nanoparticles have a particle size of 20 nm to 150 nm.

11. A method of producing Si nanoparticles using microwave plasma by an apparatus for producing Si nanoparticles using microwave plasma, the apparatus including: a reactor providing a reaction space; a precursor gas injector disposed above the reaction space and injecting a silicon precursor gas into the reaction space; an output supply unit generating microwaves using a source of a plasma torch provided to the reaction space; a swirl gas injector supplying a plasma formation gas and a reaction gas in swirl form into the reaction space; and a reaction gas injector supplying the reaction gas in linear form into a passage formed from the precursor gas injector to the reaction space,
wherein the precursor gas, the plasma formation gas, and the reaction gas react with one another along a swirl in the reactor.

12. The method of producing Si nanoparticles using microwave plasma according to claim 11, wherein the silicon precursor gas is obtained through vaporization of liquid SiCl₄.

13. The method of producing Si nanoparticles using microwave plasma according to claim 11, wherein, among the gases supplied in the swirl form into the reaction space, a flow rate of the reaction gas depends upon an amount of the silicon precursor (ml) and is in the range of 1 slpm/ml to 10 slpm/ml.

14. The method of producing Si nanoparticles using microwave plasma according to claim 11, wherein a flow rate of the reaction gas supplied in the linear form into the passage formed from the precursor gas injector to the reaction space depends upon an amount of the silicon precursor (ml) and is in the range of 1 slpm/ml to 25 slpm/ml.

15. The method of producing Si nanoparticles using microwave plasma according to claim 11, wherein the plasma formation gas supplied into the reaction space is N₂ and is supplied at a flow rate of 5 slpm/kW to 15 slpm/kW.

16. The method of producing Si nanoparticles using microwave plasma according to claim 11, wherein an amount of the silicon precursor gas is in the range of 0.1˜10.0 ml/kW at 25° C.

17. The method of producing Si nanoparticles using microwave plasma according to claim 11, wherein the silicon precursor is injected in a gaseous phase through vaporization and the vaporized precursor gas has a temperature of 100° C. to 350° C.

18. The method of producing Si nanoparticles using microwave plasma according to claim 11, wherein the produced Si nanoparticles comprise core-shell structure nanoparticles.

19. Si nanoparticles produced by the method according to claim 11.

20. A lithium secondary battery comprising the Si nanoparticles produced by the method according to claim 11 as an anode material of the lithium secondary battery.
